(19) United States
(12) Patent Application Publication
(10) Pub. No.: US 2006/0224267 A1
(43) Pub. Date: Oct. 5, 2006

(54) Method and apparatus for detecting abnormal characteristic values capable of suppressing detection of normal characteristic values

(75) Inventor: Masanobu Higashide, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/378,297

(22) Filed: Mar. 20, 2006

(30) Foreign Application Priority Data
Mar. 30, 2005 (JP) 2005-098037

(51) Int. Cl. G06F 19/00

(52) U.S. Cl. 700/109; 700/108; 702/84

(57) ABSTRACT

In a method for detecting abnormal characteristic values of a plurality of products sequentially manufactured in the same manufacturing line, it is determined whether or not a successive lower or upper tendency with respect to a control center value has occurred in a plurality of sequentially-obtained characteristic values of the products. Also, it is determined whether or not at least one of the characteristic values is located within a control region narrower than an allowable region and outside a normal region narrower than the control region. Further, when the successive lower or upper tendency has occurred and the at least one characteristic value is located within the control region outside the normal region, an alarm state is detected.

### BACKGROUND OF THE INVENTION

1. Field of the Invention

The present invention relates to a method and apparatus for detecting abnormal characteristic values of a plurality of products or lots sequentially manufactured in the same manufacturing line.

2. Description of the Related Art

In a first prior art abnormal characteristic value detecting method (see: JP-2001-67109-A), measured characteristic values depending upon lot numbers manufactured in the same manufacturing line have to fall within an allowable region. That is, when a measured characteristic value is outside the allowable region, a respective lot of this measured characteristic value is deemed to be defective, so that the respective lot is scrapped. Also, in order to decrease the number of scrapped lots, measured characteristic values are controlled to fall within a control region narrower than the allowable region. That is, when a measured characteristic value is within the allowable region but outside the control region, i.e., within an alarm region, an alarm signal is generated to carry out a countermeasure operation. Such a measured characteristic value is called an abnormal characteristic value. This will be explained later in detail.

In the above-described first prior art abnormal characteristic value detecting method, however, even if a successive-lower (or upper) tendency with respect to a control center value is generated in the measured characteristic values, no alarm signal is generated so that a measured characteristic value would be outside the allowable region due to the delay of an advance countermeasure operation.

In a second prior art abnormal characteristic value detecting method, if a certain successive-lower (or upper) tendency with respect to a control center value is generated even within the control region, an alarm signal is generated to prevent other measured characteristic values from being outside the allowable region. Even in this case, the last measured characteristic value of the tendency is called an abnormal characteristic value. This also will be explained later in detail.

### SUMMARY OF THE INVENTION

In the above-described second prior art abnormal characteristic value detecting method, however, even if measured characteristic values have a successive-lower (or upper) tendency with respect to a control center value stably around the control center value, unnecessary alarm signals are generated to request unnecessary countermeasure operations.

For example, in a thermal oxidation apparatus for forming a gate silicon oxide layer on a silicon wafer, the gate silicon oxide layer is grown by thermally oxidizing the silicon wafer at a high-temperature, oxygen atmosphere using hydrogen and nitrogen as well as oxygen. In this case, the thickness of the gate silicon oxide layer depends upon the atmospheric pressure. That is, the higher the atmospheric pressure, the thicker the gate silicon oxide layer. Therefore, measured (i.e., sequentially-obtained) characteristic values have a successive-lower (or upper) tendency with their decrease (or increase) amounts being very small in accordance with the numbers of manufactured lots. Even in this case, alarm signals are generated to request unnecessary countermeasure operations.

According to the present invention, in a method for detecting abnormal characteristic values of a plurality of products sequentially manufactured in the same manufacturing line, it is determined whether or not a successive lower or upper tendency with respect to a control center value has occurred in a plurality of sequentially-obtained characteristic values of the products. Also, it is determined whether or not at least one or the characteristic values is located within a control region narrower than an allowable region and outside a normal region narrower than the control region. Further, when the successive lower or upper tendency has occurred and the at least one characteristic value is located within the control region outside the normal region, an alarm state is detected. In other words, even when the successive lower or upper tendency has occurred, if no characteristic value is located within the control region outside the normal region, no alarm state is detected.

### BRIEF DESCRIPTION OF THE DRAWINGS

The present invention will be more clearly understood from the description set forth below, as compared with the prior art, with reference to the accompanying drawings, wherein:

FIG. 1 is a graph for explaining a first prior art abnormal characteristic value detecting method;

FIG. 2 is a graph for explaining the problem in the first prior art abnormal characteristic value detecting method of FIG. 1;

FIG. 3 is a graph for explaining a second prior art abnormal characteristic value detecting method;

FIGS. 4A and 4B are graphs for explaining the problem in the second prior art abnormal characteristic value detecting method of FIG. 3;

FIG. 5 is a block circuit diagram illustrating an embodiment of the abnormal characteristic value detecting apparatus according to the present invention;

FIG. 6 is a graph for explaining the allowable region, the control region and the normal region of FIG. 5;

FIG. 7 is a flowchart for explaining a first operation of the abnormal characteristic value detecting apparatus of FIG. 5;

FIGS. 8 and 9 are graphs for explaining the flowchart of FIG. 7;

FIG. 10 is a flowchart for explaining a second operation of the abnormal characteristic value detecting apparatus of FIG. 5;

FIG. 11 is a graph for explaining the flowchart of FIG. 10;

FIG. 12 is a flowchart for explaining a third operation of the abnormal characteristic value detecting apparatus of FIG. 5;

FIG. 13 is a graph for explaining the flowchart of FIG. 12; and

FIGS. 14, 15 and 16 are graphs illustrating modifications of the graph of FIG. 6.

### DESCRIPTION OF THE PREFERRED EMBODIMENT

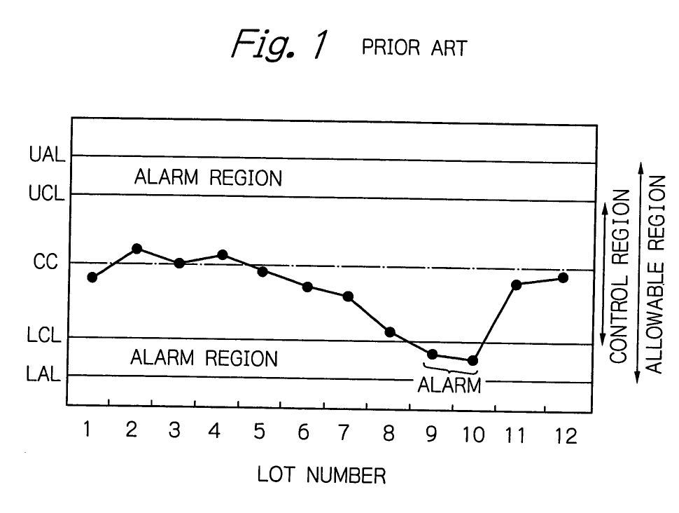

Before the description of the preferred embodiment, prior art abnormal characteristic value detecting methods will now be explained with reference to FIGS. 1, 2, 3 and 4.

In FIG. 1, which is a graph for explaining a first prior art abnormal characteristic value detecting method (see: JP-2001-67109-A), measured characteristic values depending upon sequential numbers such as lot members manufactured in the same manufacturing line have to fall within an allowable region and are controlled to be in a control region narrower than the allowable region.

The allowable region is defined by a lower allowable limit value LAL and an upper allowable limit value UAL (>LAL) centered at a control center value CC. Also, the control region is included in the allowable region and is defined by a lower control limit value LCL (>LAL) and an upper control limit value UCL (<UAL) centered at the control center value CC. In this case, an alarm region is defined by the lower allowable limit value LAL and the lower control limit value LCL, and another alarm region is defined by the upper allowable limit value UAL and the upper control limit value UCL.

When a currently-measured or last characteristic value is outside the allowable region, a respective lot of this measured characteristic value is deemed to be defective, so that a defect signal is generated.

When a currently-measured or last characteristic value is within the allowable region but outside the control region, i.e., within one of the alarm regions, alarm signals are generated for the lots 9 and 10 as shown in FIG. 1 to carry out an advance countermeasure operation.

When a currently-measured or last characteristic value is within the control region, a respective lot of this measured characteristic value is deemed to be normal, so that no defect signal and no alarm signal are generated.

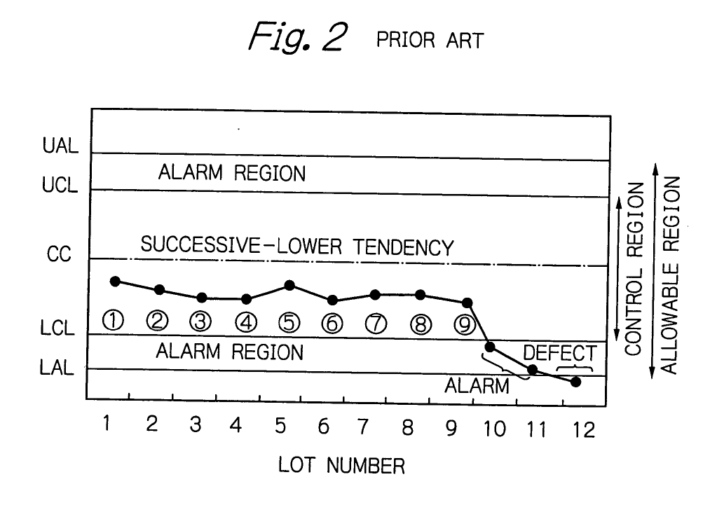

In the first prior art abnormal characteristic value detecting method of FIG. 1, however, even if a successive-lower tendency with respect to the control center value CC is generated in the measured characteristic values of the lots 1, 2, . . . , 9 as shown in FIG. 2, no alarm signal is generated for the lot 9, although alarm signals are generated only for the lots 10 and 11 in the alarm region. As a result, an advance countermeasure operation is delayed due to the delay of the generation of the alarm signals, so that the measured characteristic value of the lot 12 would be outside the allowable region so that the lot 12 is deemed to be defective as shown in FIG. 2.

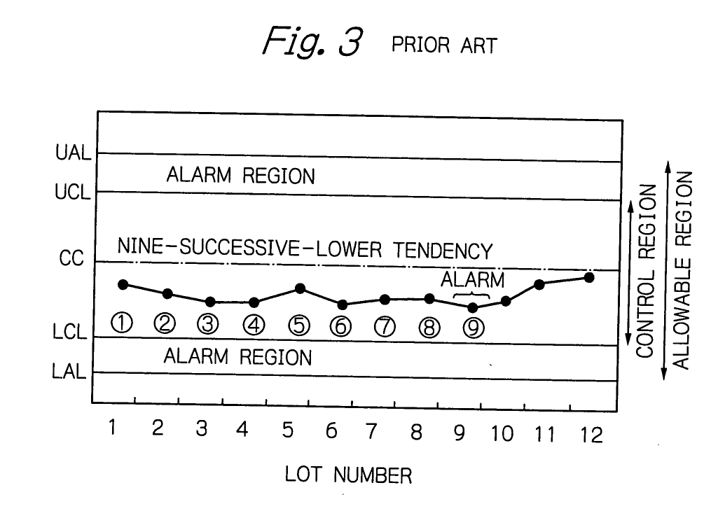

In FIG. 3, which is a graph for explaining a second prior art abnormal characteristic value detecting method, if a “nine-successive-lower tendency” is generated even within the control region, an alarm signal is generated at the last lot thereof to suppress the delay of generation of alarm signals. That is, even if the measured characteristic values of the nine successive lots 1, 2, . . . , 9 are between the lower control limit LCL and the control center value CC, an alarm signal is generated for the last lot 9. Note that “nine” of the nine-successive-lower or-upper tendency is defined by Japanese Industrial Standards (JIS) Z9021. As a result, a countermeasure operation is carried out to prevent the measured characteristic values of the lots 10, 11 and 12 from being outside the allowable region.

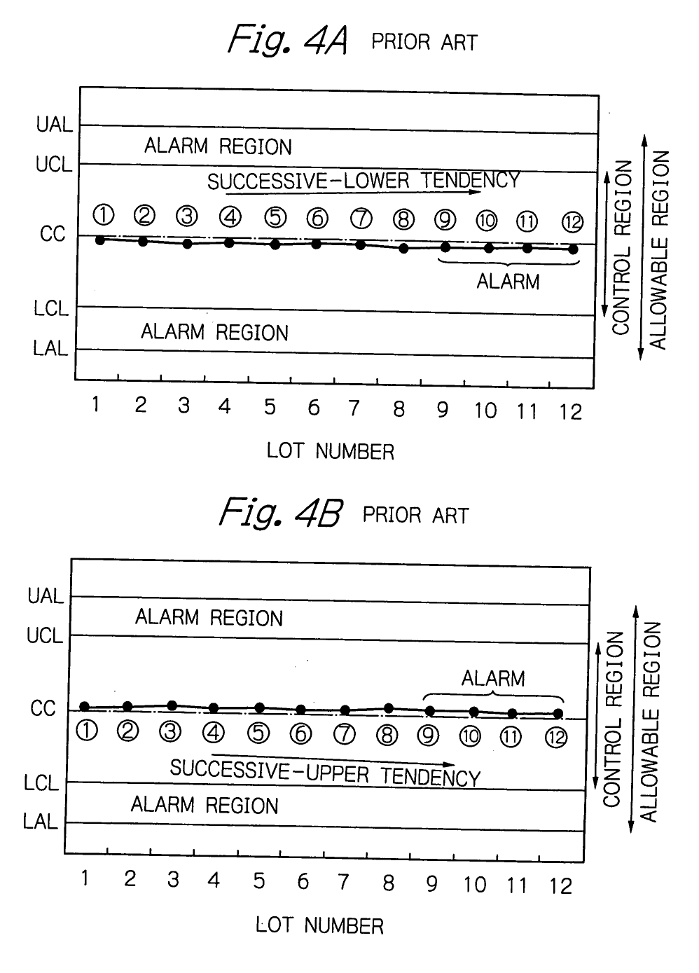

In the second prior art abnormal characteristic value detecting method of FIG. 3, however, even if the measured characteristic values of the lots 1, 2, . . . , 9 have a successive-lower tendency as shown in FIG. 4A or a successive-upper tendency as shown in FIG. 4B stably around the control center value CC, unnecessary alarm signals are generated for the lots 9, 10, 11 and 12 as shown in FIG. 4A or 4B, to request unnecessary countermeasure operations.

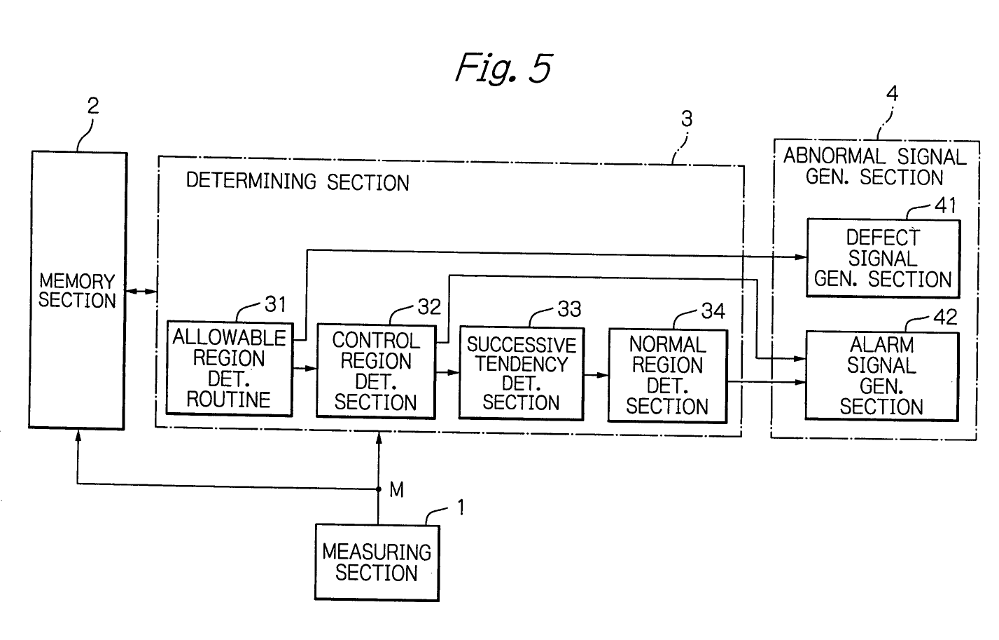

In FIG. 5, which illustrates an embodiment of the abnormal characteristic value detecting apparatus according to the present invention, a measuring section 1 such as an ellipsometer measures a characteristic value such as a thickness of silicon oxide formed on a semiconductor substrate. The measuring section 1 can measure the characteristic values of semiconductor wafers of all lots or selected lots.

A memory section 2 stores not only measured characteristic values and other temporary data, but also constants and programs.

A determining section 3 is constructed by an allowable region determining section 31, a control region determining section 32, a successive tendency determining section 33 and a normal region determining section 34.

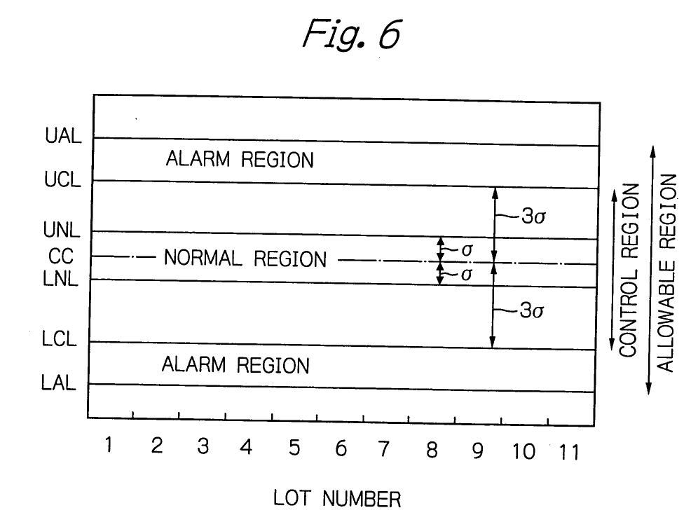

The allowable region determining section 31 determines whether or not a measured characteristic value is located within an allowable region defined by a lower allowable limit value LAL and an upper allowable limit value UAL centered at a control center value CC as shown in FIG. 6.

When the measured characteristic value is located within the allowable region, the control region determining section 32 determines whether or not the measured characteristic value is located within a control region defined by a lower control limit value LCL and an upper control limit value UCL centered at the control center value CC as shown in FIG. 6. In this case,
LAL<LCL<CC
CC<UCL<UAL

When the measured characteristic value is located within the control region, the successive tendency determining section 33 determines whether or not there is a nine-successive-lower (or upper) tendency in the measured characteristic values.

When there is a nine-successive-lower (or upper) tendency in the measured characteristic values, the normal region determining section 34 determines whether or not at least one of the measured characteristic values is located within a normal region defined by a lower normal limit value LNL and an upper normal limit value UNL as shown in FIG. 6. In this case,
LCL<LNL<CC
CC<UNL<UCL

An abnormal signal generating section 4 is constructed by a defect signal generating section 41 and an alarm signal generating section 42.

When the currently-measured or last characteristic value is determined to be located outside the allowable region, the defect signal generating section 41 generates a defect signal adapted to activate a first sound element or a first visual element (not shown).

When the currently-measured or last characteristic value is determined to be located within the allowable region but outside the control region, and when at least one of the measured characteristic values is within the control region but outside the normal region when a nine-successive-lower (or upper) tendency occurs therein, the alarm signal generating section 42 generates an alarm signal adapted to activate a second sound element or a second visual element (not shown).

In FIG. 6, note that
CC−LCL=UCL−CC=3σ
CC−LNL=UNL−CC=σ

where σ is a standard deviation of the measured characteristic values if they have a normal distribution within the allowable region.

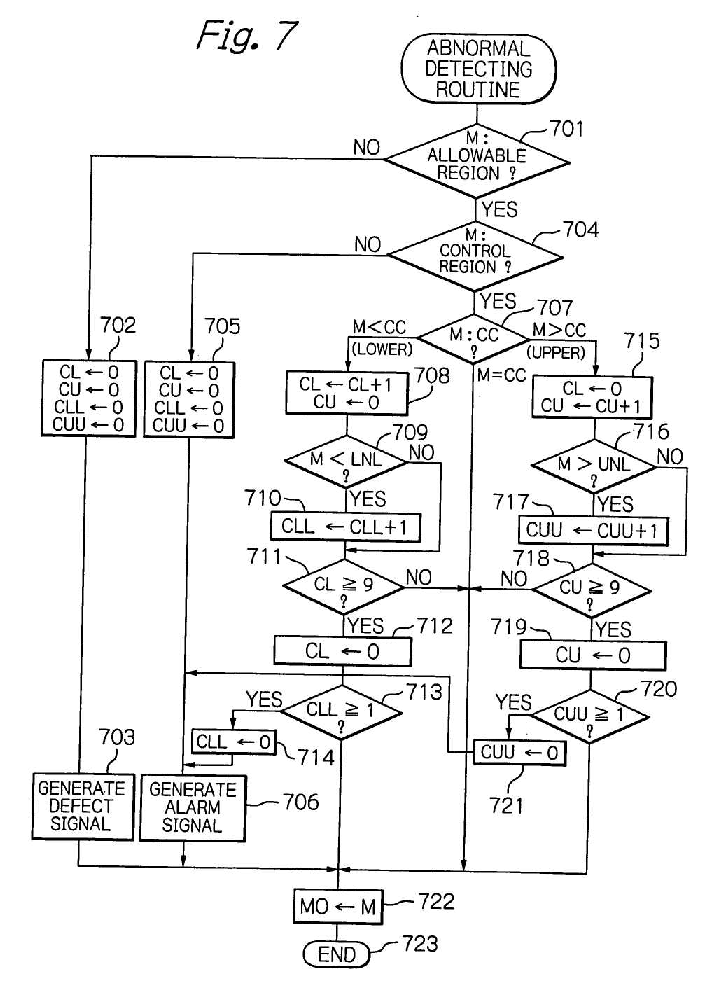

The memory section 2, the determining section 3 and the abnormal signal generating section 4 of FIG. 5 are constructed by a computer formed of a central processing unit (CPU), a random access memory (RAM) for storing the measured characteristic values and other temporary data, a read-only memory (ROM) for storing constants and programs, and so on. In this case, the operation of the CPU is carried out by a flowchart as illustrated in FIG. 7. In FIG. 7, an initial routine (not shown) is carried out in advance, so that a lower counter value CL, an upper counter value CU, a lowermost counter value CLL, and an uppermost counter value CUU are initialized at 0, and a previously-measured characteristic value M0 is initialized at the center control value CC. Note that the routine of FIG. 7 is carried out every time the measuring section 1 generates a measured characteristic value fetch request signal to be sent to the computer.

First, at step 701, it is determined whether or not the measured characteristic value M is within the allowable region, i.e.,
LAL<M<UAL.

As a result, when the measured characteristic value M is not within the allowable region (M≦LAL or M≧UAL), the control proceeds to steps 702 and 703. That is, at step 702, the counter values CU, CL, CUU and CLL are reset (CU=CL=CUU=CLL=0). Also, at step 703, a defect signal is generated. As a result, a respective lot of this measured characteristic value is deemed to be defective.

On the other hand, at step 701, when it is determined that the measured characteristic value M is within the allowable region (LAL<M<UAL), the control proceeds to step 704 which determines whether or not the measured characteristic value M is within the control region, i.e.,
LCL<M<UCL.

As a result, when the measured characteristic value M is not within the control region (M≦LCL or M≧UCL), the control proceeds to steps 705 and 706. That is, at step 705, the counter values CU, CL, CUU and CLL are reset (CU=CL=CUU=CLL=0). Also, at step 706, an alarm signal is generated. As a result, a countermeasure operation would be carried out.

On the other hand, at step 704, when it is determined that the measured characteristic value M is within the control region (LCL<M<UCL), the control proceeds to step 707 which determines whether or not the measured characteristic value M is smaller than CC, equal to CC, or larger than CC. As a result, when M<CC (lower state), the control proceeds to steps 708 through 714. Also, when M<CC (upper state), the control proceeds to steps 715 through 721. Further, when M=CC, the control proceeds directly to step 722.

At step 708, the lower counter value CL is counted up by 1, i.e., CL=CL+1, while the upper counter value CU is reset, i.e., CU=0. Then, at step 709, it is determined whether or not M<LNL, i.e., the last measured characteristic value M is within the normal region. As a result, only when M<LNL, does the control proceed to step 710 which increments the lowermost counter value CLL by +1. Then, as step 711, it is determined whether or not CL≧9, i.e., a nine-successive-lower tendency occurs in the measured characteristic values. Only when CL≧9, does the control proceed to step 712 which resets the lower counter value CL, i.e., CL=0. Then, at step 713, it is determined whether or not CLL≧1. Only when CLL≧1, does the control proceed to step 714 which resets the counter value CLL, and then proceed to step 706 which generates an alarm signal. Thus, when the nine successive characteristic values are lower than the control center value CC and at least one of the characteristic values is within the control region outside the normal region, an alarm signal is generated.

On the other hand, at step 715, the lower counter value CL is reset, i.e., CL=0, while the upper counter value CU is counted up by 1, i.e., CU=CU+1. Then, at step 716, it is determined whether or not M>UNL, i.e., the last measured characteristic value M is within the normal region. As a result, only when M>UNL, does the control proceed to step 717 which increments the uppermost counter value CUU by +1. Then, at step 718, it is determined whether or not CU≧9, i.e., a nine-successive-upper tendency occurs in the measured characteristic values. Only when CL≧9, does the control proceed to step 719 which resets the upper counter value CU, i.e., CU=0. Then, at step 720, it is determined whether or not CUU≧1. Only when CUU≧1, does the control proceed to step 721 which resets the counter value CUU, and then proceed to step 706 which generates an alarm signal. Thus, when the nine successive characteristic values are higher than the control center value CC and at least one of the characteristic values is within the control region outside the normal region, an alarm signal is generated.

The control at steps 703 and 706 proceeds to step 722. Also, when the counter value CLL or CUU is 0 at step 713 or 720, the control proceeds to step 722. At step 722, the previously-measured characteristic value M0 is replaced by the currently-measured characteristic value M, and the control proceeds to step 723 which prepares for the next measured characteristic value fetch request signal.

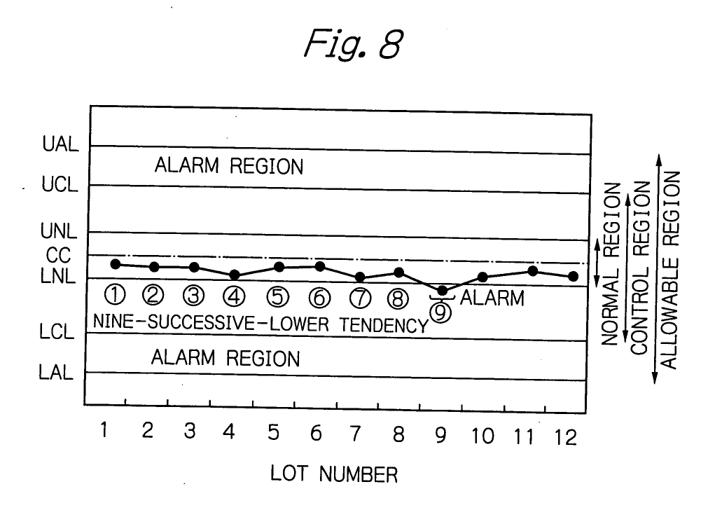

According to a first example as illustrated in FIG. 8, if a “nine-successive-lower tendency” is generated even within the control region, the measured characteristic value of the lot 9 is outside the normal region, so that an alarm signal is generated at the last lot to suppress the delay of generation of alarm signals. That is, if the measured characteristic values of the nine successive lots 1, 2, . . . , 9 are successively lower than the control center value CC, an alarm signal is generated for the last lot 9. As a result, a countermeasure operation is carried out to prevent the measured characteristic values of the lots 10, 11 and 12 from being outside the allowable region.

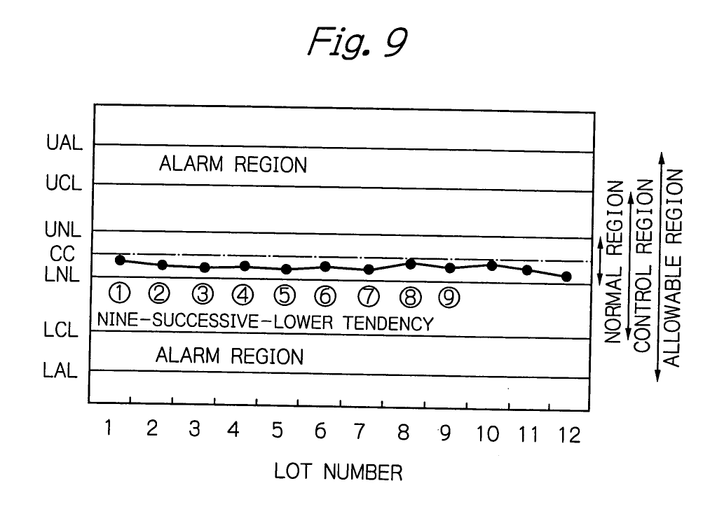

According to a second example as illustrated in FIG. 9, even if the measured characteristic values of the lots 1, 2, . . . , 9 have a successive-lower tendency stably around the control center value CC, unnecessary alarm signals are not generated, so that unnecessary countermeasure operations are not requested.

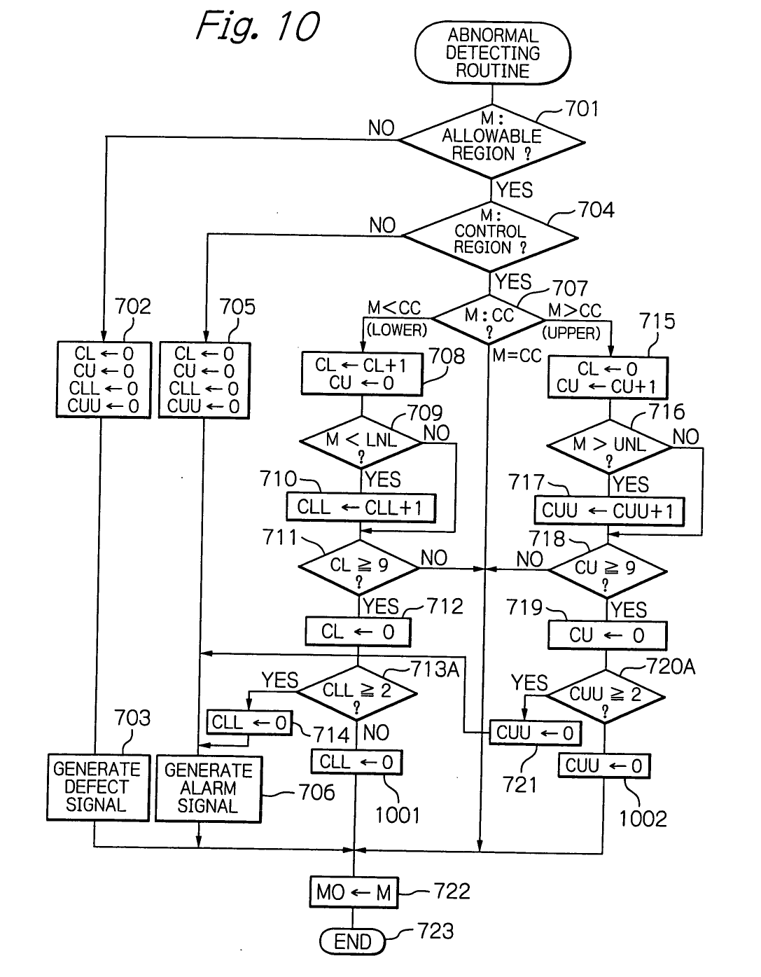

In FIG. 10, which is a modification of the flowchart of FIG. 7, steps 713 and 720 of FIG. 7 are replaced by steps 713A and 720A, respectively, and steps 1001 and 1002 are added after steps 713A and 720A, respectively.

At step 713A, it is determined whether or not CLL≧2, i.e., at least two measured characteristic values are within the control region excluding the normal region. As a result, only when CLL≧2, does the control proceed via step 714 to step 706 which generates an alarm signal. Thus, when the nine successive characteristic values are lower than the control center value CC and the two measured characteristic values are within the control region excluding the normal region, an alarm signal is generated.

At step 720A, it is determined whether or not CUU≧2, i.e., at least two measured characteristic values are within the control region excluding the normal region. As a result, only when CUU≧2, does the control proceed via step 721 to step 706 which generates an alarm signal. Thus, when the nine successive characteristic values are higher than the control center value CC and the two measured characteristic values are within the control region excluding the normal region, an alarm signal is generated.

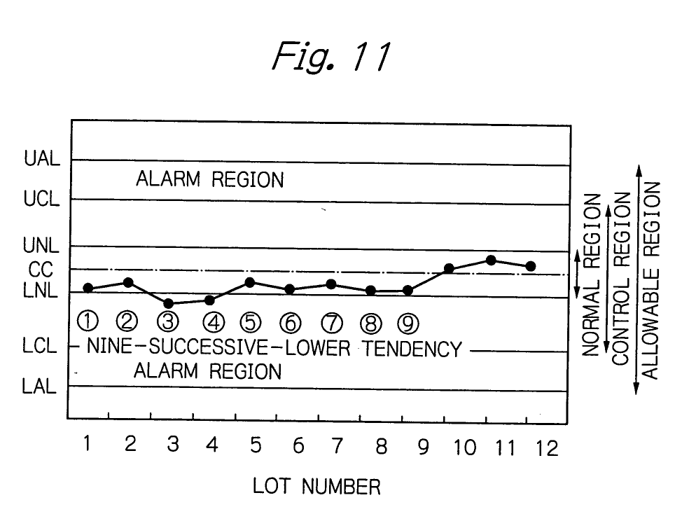

According to an example as illustrated in FIG. 11, if a “nine-successive-lower tendency” is generated even within the control region, the two measured characteristic values are outside the normal region, so that an alarm signal is generated at the last lot thereof to suppress the delay of generation of alarm signals. That is, if the measured characteristic values of the nine successive lots 1, 2, . . . , 9 are successively lower than the control center value CC, an alarm signal is generated for the last lot 9. As a result, a countermeasure operation is carried out to prevent the measured characteristic values of the lots 10, 11 and 12 from being outside the allowable region.

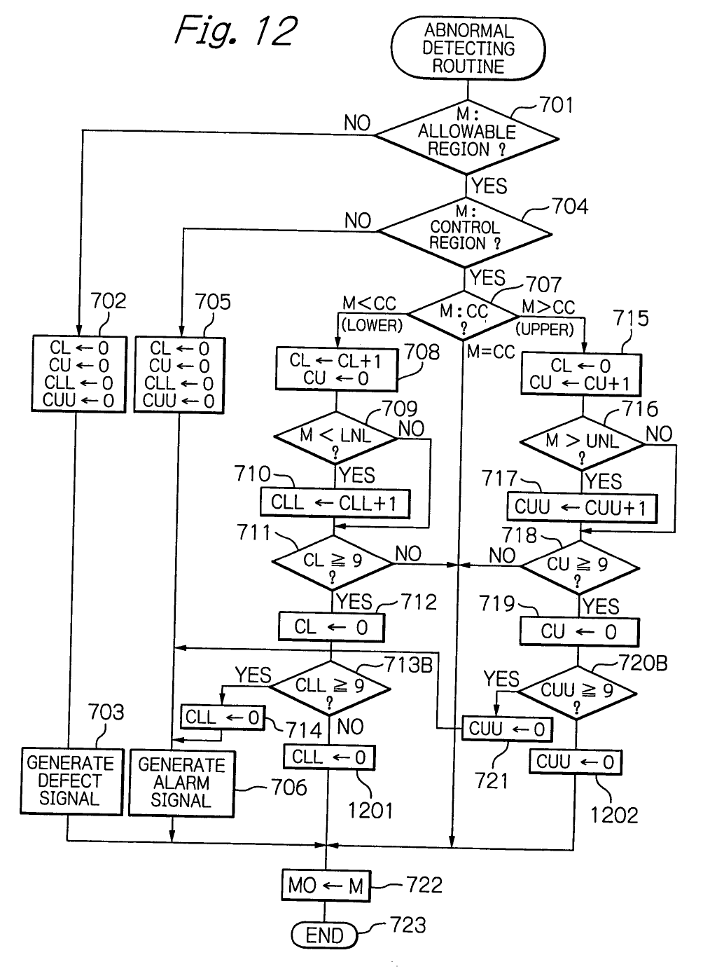

In FIG. 12, which is another modification of the flowchart of FIG. 7, steps 713 and 720 of FIG. 7 are replaced by steps 713B and 720B, respectively, and steps 1201 and 1202 are added after steps 713B and 720B, respectively.

At step 713B, it is determined whether or not CLL≧9, i.e., all the nine measured characteristic values are within the control region excluding the normal region. As a result, only when CLL≧9, does the control proceed via step 714 to step 706 which generates an alarm signal. Thus, when the nine successive characteristic values are lower than the control center value CC and within the control region excluding the normal region, an alarm signal is generated.

At step 720B, it is determined whether or not LUU≧9, i.e., all the nine measured characteristic values are within the control region excluding the normal region. As a result, only when CUU≧9, does the control proceed via step 721 to step 706 which generates an alarm signal. Thus, when the nine center successive characteristic values are higher than the control value CC and within the control region excluding the normal region, an alarm signal is generated.

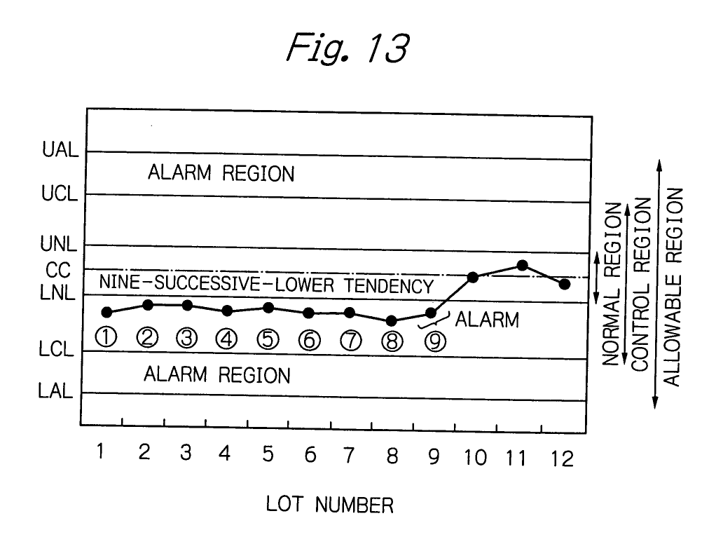

According to an example as illustrated in FIG. 13, if a “nine-successive-lower tendency” is generated even within the control region, all the nine measured characteristic values are outside the normal region, so that an alarm signal is generated at the last lot thereof to suppress the delay of generation of alarm signals. That is, if the measured characteristic values of the nine successive lots 1, 2, . . . , 9 are successively lower than the control center value CC, an alarm signal is generated for the last lot 9. As a result, a countermeasure operation is carried out to prevent the measured characteristic values of the lots 10, 11 and 12 from being outside the allowable region.

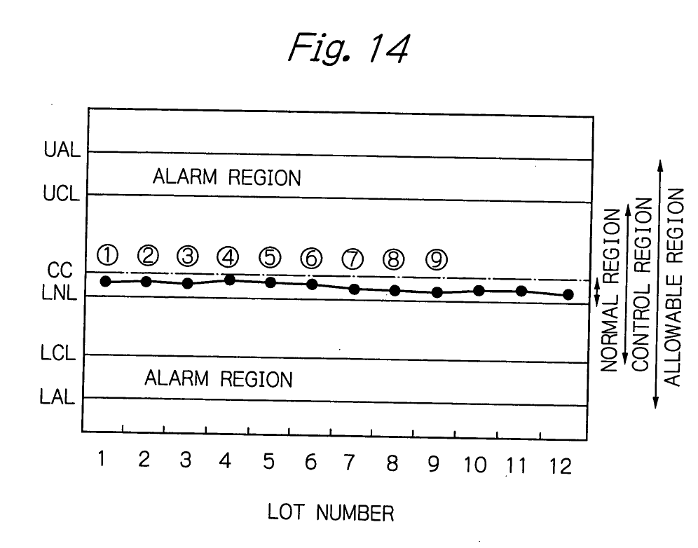

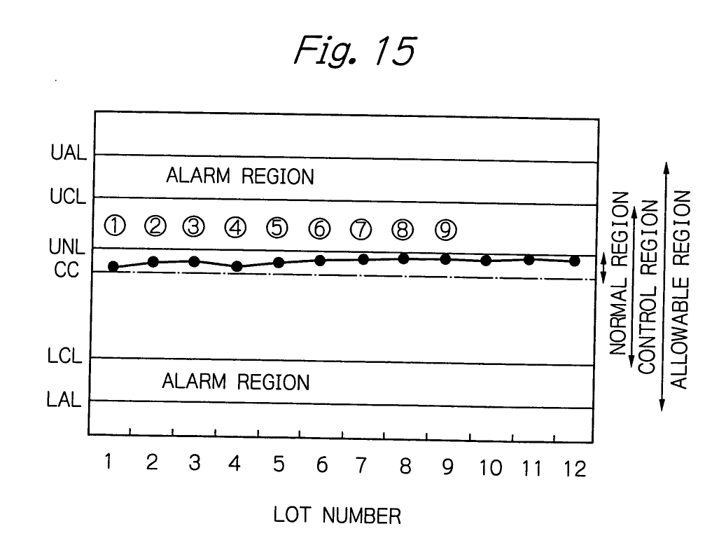

In FIG. 6, the normal region is provided to bridge the control center value CC. However, the normal region can be provided on one side of the control center value CC as illustrated in FIGS. 14 and 15. That is, in FIG. 14, the normal region is provided only below the control center value CC. In this case, the present invention can be applied to only the case where a successive lower tendency occurs, i.e., where steps 715 through 721 (720A, 1002, 720B, 1202) are deleted from FIG. 7 (10, 12) so that the condition of M>CC at step 707 leads to step 722. Similarly, in FIG. 15, the normal region is provided only above the control center value CC. In this case, the present invention can be applied to only the case where a successive upper tendency occurs, i.e., where steps 708 through 714 (713A, 1001, 713B, 1201) are deleted from FIG. 7 (10, 12) so that the condition of M<CC at step 707 leads to step 722.

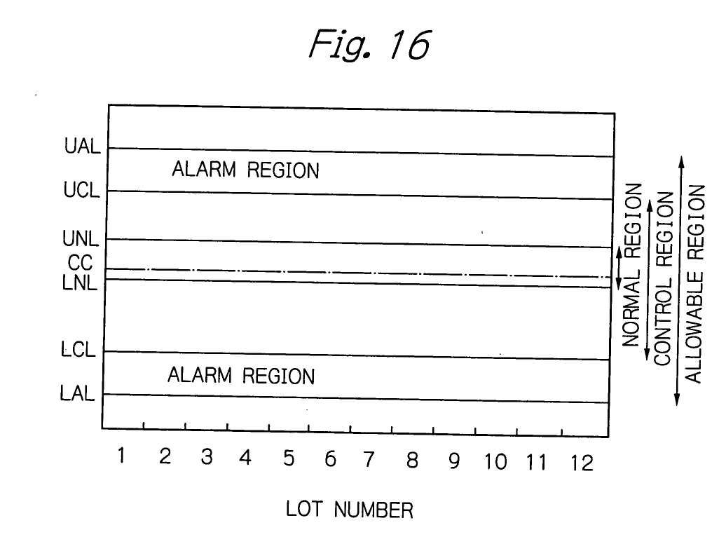

In FIG. 6, the normal region is symmetrical with respect to the control center value CC. However, the normal region can be asymmetrical with respect to the control center value CC as illustrated in FIG. 16. That is, in FIG. 16, the normal region above the control center value CC is wider than the normal region below the control center value CC. As a result, if the measured characteristic values are slightly higher rather than lower with respect to the control center value CC in a normal state, unnecessary alarm signals can be effectively suppressed to decrease unnecessary countermeasure operation requests.

1. A method for detecting abnormal characteristic values of a plurality of products sequentially manufactured in the same manufacturing line, comprising:
determining whether or not a successive lower tendency with respect to a control center value has occurred in a plurality of sequentially-obtained characteristic values of said products;
determining whether or not at least one of said characteristic values is located within a control region narrower than an allowable region and outside a normal region narrower than said control region; and
detecting an alarm state when said successive lower tendency has occurred and said at least one characteristic value is located within said control region outside said normal region.

2. The method as set forth in claim 1, further comprising generating an alarm signal when said alarm state is detected.

3. The method as set forth in claim 1, wherein a lower limit of said normal region is above a lower limit of said control region and below a control center value, and wherein an upper limit of said normal region is above said control center value and below an upper limit of said control region.

4. The method as set forth in claim 3, wherein a difference between the lower limit of said normal region and said control center value is different from a difference between said control center value and the upper limit of said normal region.

5. The method as set forth in claim 1, wherein a lower limit of said normal region is above a lower limit of said control region and below a control center value, and wherein an upper limit of said normal region is the same as said control center value.

6. A method for detecting abnormal characteristic values of a plurality of products sequentially manufactured in the same manufacturing line, comprising:
determining whether or not a successive upper tendency with respect to a control center value has occurred in a plurality of sequentially-obtained characteristic values of said products including a currently-obtained characteristic value;
determining whether or not at least one of said characteristic values is located within a control region narrower than an allowable region and outside a normal region narrower than said control region; and
detecting an alarm state when said successive upper tendency has occurred and said at least one characteristic value is located within said control region outside said normal region.

7. The method as set forth in claim 6, further comprising generating an alarm signal when said alarm state is detected.

8. The method as set forth in claim 6, wherein a lower limit of said normal region is above a lower limit of said control region and below a control center value, and wherein an upper limit of said normal region is above said control center value and below an upper limit of said control region.

9. The method as set forth in claim 8, wherein a difference between the lower limit of said normal region and said control center value is different from a difference between said control center value and the upper limit of said normal region.

10. The method as set forth in claim 6, wherein a lower limit of said normal region is the same as said control center value, and wherein an upper limit of said normal region is above said control center value and lower an upper limit of said control region.

11. An apparatus for detecting abnormal characteristic values of a plurality of products sequentially manufactured in the same manufacturing line, comprising:
a successive lower tendency determining section for determining whether or not a successive lower tendency has occurred in a plurality of sequentially-obtained characteristic values of said products; and
a normal region determining section for determining whether or not at least one of said characteristic values is located within a control region narrower than an allowable region and outside a normal region narrower than said control region,
thus detecting an alarm state when said successive lower tendency has occurred and said at least one characteristic value is located within said control region outside said normal region.

12. The apparatus as set forth in claim 11, further comprising an alarm generating section for generating an alarm signal when said alarm state is detected.

13. The apparatus as set forth in claim 11, wherein a lower limit of said normal region is above a lower limit of said control region and below a control center value, and wherein an upper limit of said normal region is above said control center value and below an upper limit of said control region.

14. The apparatus as set forth in claim 13, wherein a difference between the lower limit of said normal region and said control center value is different from a difference between said control center value and the upper limit of said normal region.

15. The method as set forth in claim 11, wherein a lower limit of said normal region is above a lower limit of said control region and below a control center value, and wherein an upper limit of said normal region is the same as said control center value.

16. An apparatus for detecting abnormal characteristic values of a plurality of products sequentially manufactured in the same manufacturing line, comprising:
a successive upper tendency determining section for determining whether or not a successive upper tendency has occurred in a plurality of sequentially-obtained characteristic values of said products; and
a normal region determining section for determining whether or not at least one of said characteristic values is located within a control region narrower than an allowable region and outside a normal region narrower than said control region,
thus detecting an alarm state when said successive upper tendency has occurred and said at least characteristic value is located within said control region outside said normal region.

17. The apparatus as set forth in claim 16, further comprising an alarm generating section for generating an alarm signal when said alarm state is detected.

18. The apparatus as set forth in claim 16, wherein a lower limit of said normal region is above a lower limit of said control region and below a control center value, and wherein an upper limit of said normal region is above said control center value and below an upper limit of said control region.

19. The apparatus as set forth in claim 18, wherein a difference between the lower limit of said normal region and said control center value is different from a difference between said control center value and the upper limit of said normal region.

20. The apparatus as set forth in claim 16, wherein a lower limit of said normal region is the same as said control center value, and wherein an upper limit of said normal region is above said control center value and lower than an upper limit of said control region.
